(19) United States
(12) Patent Application Publication
(10) Pub. No.: US 2022/0100032 A1
(43) Pub. Date: Mar. 31, 2022

(54) Electronic Compensation Methods and Systems for Optical Devices Using Liquid Crystal Based Microdisplay Devices

(71) Applicant: Lumus Ltd., Ness Ziona (IL)

(72) Inventor: Eitan RONEN, Rechovot (IL)

(21) Appl. No.: 17/423,873

(22) PCT Filed: Jan. 28, 2020
(86) PCT No.: PCT/IB2020/050649

§ 371 Date: Jul. 18, 2021

Related U.S. Application Data
(60) Provisional application No. 62/797,973, filed on Jan. 29, 2019.

(51) Int. Cl. G02F 1/1335; G02F 1/13363; H04N 9/31; G02F 1/13

(52) U.S. Cl. CPC G02F 1/133531; G02F 1/1309; H04N 9/3167; G02F 1/133638

(57) ABSTRACT

An electronic display device and a birefringent element are obtained. The electronic display device has liquid crystal material deployed between two transparent electrodes. The electronic display device and the birefringent element each have respective polarization axes. The electronic display device and the birefringent element are deployed relative to each other such that the polarization axes of the electronic display device are rotationally offset from the polarization axes of the birefringent element by an offset amount in accordance with a predetermined direction of rotation. A compensation voltage that is proportional to the offset amount is determined. The compensation voltage is applied across the transparent electrodes to induce the liquid crystal material to assume an intermediate state. The electronic display device produces polarized image light waves having polarization in a polarization direction in accordance with the intermediate state assumed by the liquid crystal material and that compensates for the rotational offset.

### CROSS-REFERENCE TO RELATED APPLICATIONS

This application claims priority from U.S. Provisional Patent Application No. 62/797,973, filed Jan. 29, 2019, whose disclosure is incorporated by reference in its entirety herein.

### TECHNICAL FIELD

The present invention relates to optical devices and systems, in particular optical devices and systems that include image projecting optical devices that project images produced by liquid-crystal-based electronic microdisplay devices, such as liquid crystal on silicon (LCoS) display devices and liquid crystal display (LCD) devices.

### BACKGROUND OF THE INVENTION

Compact optical devices are particularly needed in the field of head-mounted displays (HMDs) and near-eye displays (NEDs), wherein an optical module performs functions of image generation and collimation of the image to infinity, for delivery to the eye of the viewer. The image can be obtained from an electronic display device, either directly from a spatial light modulator (SLM), such as a cathode ray tube (CRT), a liquid crystal display (LCD), a liquid crystal on silicon (LCoS), a digital micro-mirror device (DMD), an OLED display, a scanning source or similar devices, or indirectly, by means of a relay lens or an optical fiber bundle. The image, made up of an array of pixels, is focused to infinity by a collimating arrangement and transmitted into the eye of the viewer, typically by a reflecting surface or a partially reflecting surface acting as a combiner, for non-see-through applications and see-through applications, respectively. Typically, a conventional, free-space optical module is used for these purposes.

A particularly advantageous family of solutions for HMDs and NEDs are commercially available from Lumus Ltd. (Israel), typically employing light-guide substrates (optical waveguides) with partially reflecting surfaces or other applicable optical elements for delivering an image to the eye of a user.

In optical architectures that rely on liquid-crystal-based devices as the display device, such as LCoS or LCD, the display device emits polarized light waves in response to illumination by illumination optics (which includes a source of polarized light). The polarized light waves emitted by the display device pass through imaging optics to produce collimated polarized image light waves, which in the case of the aforementioned family of solutions for HMDs and NEDs are then coupled into a light-guide substrate.

Birefringent elements are typically used in deployment between the display device and the illumination optics in order to suppress the transmission of unwanted light to the imaging optics. For reflective display devices, e.g., LCoS, the birefringent element is deployed between the output of the display device and the illumination optics. For backlit display devices, e.g., LCD, the birefringent element is deployed between the illumination optics and the input of the display device.

FIG. 1 shows a schematic representation of a non-limiting example of an image projecting optical device 10 (referred to hereinafter as image projector 10) having a display device 12 implemented as a reflective display device, i.e., LCoS, that produces collimated polarized image light waves that can be injected into a light-guide substrate. An illumination prism 20, formed from a light-wave transmitting material, that has a number of external surfaces including a light-wave entrance surface 28, an image display surface 30, and a light-wave exit surface 32. A polarization-selective beamsplitter configuration 22 (referred to in short as PBS 22) is deployed within the illumination prism 20 on a plane oblique to the light-wave entrance surface 28. The illumination prism 20 is based on (i.e., formed from) two constituent prisms, labeled 24 and 26, where at least one of the prisms 24, 26 is provided on the hypotenuse side with a polarizing beamsplitter forming at least part of PBS 22. The two hypotenuse sides of the prisms 24, 26 are cemented to each other to form a cemented illumination prism assembly, i.e., the illumination prism 20. The illumination prism 20 is used for illumination of the display device 12.

A source of polarized light, shown here as a combination of a light source 14, for example a light emitting diode (LED), with a linear polarizer 16, is associated with the light-wave entrance surface 28. The display device 12 is associated with the image display surface 30, and generates spatial modulation of reflected light corresponding to an image. Light from the source of polarized light, generally designated as incident beam 18, is reflected by the PBS 22 so as to illuminate the display device 12. The display device 12 is configured such that the reflected light corresponding to a bright region of a desired image has a polarization rotated relative to the source of polarized light. Thus, as shown in FIG. 1, polarized illumination (i.e., incident beam 18) enters the illumination prism 20 through the light-wave entrance surface 28 with a first polarization, typically an s-polarization relative to the PBS 22, and is reflected towards the image display surface 30 where it impinges on the display device 12. Pixels corresponding to bright regions of the image are reflected with modulated rotated polarization (typically p-polarization) so that radiation (reflected beam designated as 19) from the bright pixels is transmitted through the PBS 22 and reaches collimating optics 36 (shown here as a lens for simplicity, but may in actuality be formed as a prism, one or more retardation plate, and one or more collimating lens), which collimate the light waves.

In order to limit the propagation of slant and skew rays (having directional components coming out of the plane of the paper in FIG. 1, i.e., along the y-axis) to the collimating optics 36, a birefringent element 34 (for example a polarization compensator, a quarter wave plate, a full wave plate, etc.) is deployed between the image display surface 30 and the display device 12. In order to minimize the effect of slant/skew rays, the birefringent element 34 must be properly aligned with the plane of the display device 12. This entails aligning the Eigen axes (ordinary and extraordinary axes) of the birefringent element 34 with the corresponding Eigen axes (ordinary and extraordinary axes) of the display device 12. Typically, if the Eigen axes are misaligned there can be significant leakage in terms of the output polarization of the light waves emitted by the image projector 10. For example, if the birefringent element 34 is misaligned by an angle of θ radians, the polarization direction of the output light waves may change by 2θ, and the leakage may be approximated according to Malus's law as 4θ². In order to reduce leakage, active alignment techniques have been proposed, in which the birefringent element 34 and the display device 12 are mechanically rotated relative to each other until the respective Eigen axes are aligned within a prescribed tolerance. However, such active alignment techniques are complex, and require specialized optical test bench equipment, which can be prohibitively expensive.

### SUMMARY OF THE INVENTION

The present invention is directed to methods, system and devices that electronically compensate for the misalignment of an optical element, in particular a birefringent element, with a liquid-crystal-based electronic display device.

According to the teachings of an embodiment of the present invention, there is provided a method. The method comprises: obtaining an electronic display device and a birefringent element, the electronic display device having at least one layer of liquid crystal material deployed between two transparent electrodes, and the electronic display device and the birefringent element each having respective polarization axes; deploying the electronic display device and the birefringent element relative to each other such that the polarization axes of the electronic display device are rotationally offset from the polarization axes of the birefringent element by an offset amount in accordance with a predetermined direction of rotation; and determining a compensation voltage, proportional to the offset amount, that when applied across the transparent electrodes induces the liquid crystal material to assume an intermediate state, such that the electronic display device produces polarized image light waves having polarization in a polarization direction that is in accordance with the intermediate state assumed by the liquid crystal material and that compensates for the rotational offset between the polarization axes of the electronic display device and the birefringent element.

Optionally, the electronic display device comprises a liquid crystal on silicon display.

Optionally, the birefringent element includes a quarter wave plate.

Optionally, the birefringent element includes a full wave plate.

Optionally, the birefringent element includes a polarization compensator.

Optionally, the offset amount is within a predetermined range based on expected tolerances of the polarization axes of the electronic display device and the birefringent element.

Optionally, the determining the compensation voltage includes: applying a voltage across the transparent electrodes, and iteratively evaluating at least one image quality metric of the polarized image light waves produced in response to the applied voltage and adjusting the applied voltage until the at least one image quality metric satisfies a performance criterion.

Optionally, the method further comprises: passing the polarized image light waves emitted by the electronic display device through an optical arrangement prior to evaluating the at least one image quality metric.

There is also provided according to an embodiment of the teachings of the present invention a system. The system comprises: a power supply arrangement configured to output voltage over a range of voltages, and coupled to an electrical connection arrangement that provides an electrical coupling between the power supply arrangement and transparent electrodes of an electronic display device, the electronic display device having at least one layer of liquid crystal material deployed between the transparent electrodes; an analyzer configured to evaluate at least one image quality metric of polarized image light waves emitted by the electronic display device; and a polarization sensitive beamsplitter deployed in an optical path between the electronic display device and the analyzer. The polarization sensitive beamsplitter is configured to transmit the polarized image light waves produced by the electronic display device, and a birefringent is deployed relative to the electronic display device such that polarization axes of the electronic display device are rotationally offset from polarization axes of the birefringent element by an offset amount in accordance with a predetermined direction of rotation, and the power supply arrangement is configured to output a compensation voltage, proportional to the offset amount, that when applied across the transparent electrodes induces the liquid crystal material to assume an intermediate state, such that the electronic display device produces polarized image light waves having polarization in a polarization direction that is in accordance with the intermediate state assumed by the liquid crystal material and that compensates for the rotational offset between the polarization axes of the electronic display device and the birefringent element.

Optionally, the electronic display device comprises a liquid crystal on silicon display.

Optionally, the birefringent element includes a quarter wave plate.

Optionally, the birefringent element includes a polarization compensator.

Optionally, the offset amount is within a predetermined range based on expected tolerances of the polarization axes of the electronic display device and the birefringent element.

Optionally, the system further comprises: a control unit including at least one processor coupled to a storage medium, the control unit operatively coupled to the power supply arrangement and the analyzer and configured to: receive the image quality metric from the analyzer, and adjust the output voltage of the power supply arrangement until the image quality metric satisfies a performance criterion.

There is also provided according to an embodiment of the teachings of the present invention a method for compensating for misalignment between a birefringent element and an electronic display device having at least one layer of liquid crystal material deployed between two transparent electrodes, the electronic display device and the birefringent element each having respective polarization axes, the electronic display device configured to receive a range of applied voltages across the transparent electrodes between a minimum voltage and a maximum voltage and including a default voltage. The method comprises: deploying the electronic display device and the birefringent element relative to each other such that the polarization axes of the electronic display device are rotationally offset from the polarization axes of the birefringent element by an offset amount in accordance with a predetermined direction of rotation; and applying a change to voltage setting of a display driver associated with the electronic display device such that the default voltage is proportionally reduced in accordance with the offset amount to produce a proportionally reduced default voltage, and such that when the proportionally reduced default voltage is applied across the transparent electrodes the liquid crystal material assumes an intermediate state such that the electronic display device produces polarized image light waves having polarization in a polarization direction that is in accordance with the intermediate state assumed by the liquid crystal material and that compensates for the rotational offset between the polarization axes of the electronic display device and the birefringent element.

There is also provided according to an embodiment of the teachings of the present invention a display module. The display module comprises: an electronic display device including at least one layer of liquid crystal material deployed between two transparent electrodes, the liquid crystal material having polarization axes that define polarization axes of the electronic display device, the electronic display device associated with a display driver that controls voltage settings associated with the electronic display device, the voltage settings including a default voltage that can be applied across the transparent electrodes; and a birefringent element optically coupled to the electronic display device and having polarization axes. The electronic display device and the birefringent element are deployed relative to each other such that the polarization axes of the electronic display device are rotationally offset from the polarization axes of the birefringent element by an offset amount in accordance with a predetermined direction of rotation, and the voltage settings of the display driver are changed such that the default voltage is proportionally reduced in accordance with the offset amount to produce a proportionally reduced default voltage, and such that when the proportionally reduced default voltage is applied across the transparent electrodes the liquid crystal material assumes an intermediate state such that the electronic display device produces polarized image light waves having polarization in a polarization direction that is in accordance with the intermediate state assumed by the liquid crystal material and that compensates for the rotational offset between the polarization axes of the electronic display device and the birefringent element.

Optionally, the electronic display device is configured to operate in a normally white mode.

Optionally, the electronic display device is configured to operate in a normally dark mode.

Optionally, the electronic display device comprises a liquid crystal on silicon display, and one of the transparent electrodes is deployed between the at least one layer of liquid crystal and a reflecting surface.

There is also provided according to an embodiment of the teachings of the present invention an image projector for projecting image light waves. The image projector comprises: the display module; a prism including: a plurality of external surfaces including a light-wave entrance surface, an image display surface associated with the electronic display device, and a light-wave exit surface, and a polarization sensitive beamsplitter configuration deployed within the prism on a plane oblique to the light-wave entrance surface; and a source of polarized light associated with the light-wave entrance surface configured to produce linearly polarized light, such that polarized light produced by the source of polarized light enters the prism through the light-wave entrance surface, is reflected by the polarization sensitive beamsplitter configuration, impinges on the electronic display device via the image display surface such that the electronic display device generates spatial modulation of the polarized light corresponding to an image and such that the polarized light is reflected by the reflecting surface and has a polarization rotated relative to the source of polarized light, and such that the reflected light re-enters the prism via the image display surface and is transmitted by the polarization sensitive beamsplitter configuration, and exits the prism through the light-wave exit surface.

There is also provided according to an embodiment of the teachings of the present invention an optical device. The optical device comprises: the image projector and a light-guiding substrate having at least two major surfaces parallel to each other, the projected image light waves produced by the image projector are coupled into the light-guiding substrate.

As used herein, the term “light-guide” refers to any light-waves transmitting body, preferably light-waves transmitting solid bodies, which may also be referred to as “optical substrates”.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a schematic exploded plan view of an image projecting optical device, having an electronic display device and a birefringent element, for which the methods according to embodiments of the present disclosure can be applied;

FIG. 2 is a schematic exploded plan view of the electronic display device of FIG. 1, implemented as a twisted nematic liquid crystal on silicon (LCoS) display;

FIG. 3A is a schematic diagram illustrating the polarization effects on light traversing through the birefringent element and the twisted nematic LCoS when the LCoS operates in a normally white mode and is in a low voltage twisted state (white state);

FIG. 3B is a schematic diagram illustrating the polarization effects on light traversing through the birefringent element and the twisted nematic LCoS when the LCoS operates in the normally white mode and is in a high voltage aligned state (black state);

FIG. 4A illustrates transmission curves for an LCoS, operating in the normally white mode and in the black state, for the case in which no birefringent element is present, and for the case in which the birefringent element is present and the respective Eigen axes of the LCoS and the birefringent element are perfectly aligned;

FIG. 4B illustrates transmission curves for an LCoS, operating in the normally white mode and in the white state, for the case in which no birefringent element is present, and for the case in which the birefringent element is present and the respective Eigen axes of the LCoS and the birefringent element are perfectly aligned;

FIG. 4C illustrates a contrast ratio curve of an image produced by the LCoS in the absence of the birefringent element;

FIG. 5A illustrates transmission curves for an LCoS, operating in the normally white mode and in the black state, for the case in which no birefringent element is present, and for the case in which the birefringent element is present and the respective Eigen axes of the LCoS and the birefringent element are misaligned;

FIG. 5B illustrates transmission curves for an LCoS, operating in the normally white mode and in the white state, for the case in which no birefringent element is present, and for the case in which the birefringent element is present and the respective Eigen axes of the LCoS and the birefringent element are misaligned;

FIG. 5C illustrates contrast ratio curves of an image produced by the LCoS, for the case in which no birefringent element is present, and for the case in which a birefringent element is present and the respective Eigen axes of the LCoS and the birefringent element are misaligned;

FIG. 6 is a representation of the potential range of the Eigen axes of the display device of FIG. 1;

FIG. 7 is a representation of the potential range of the Eigen axes of the birefringent element of FIG. 1;

FIG. 8 is a representation of the angular range in which the true Eigen axes of the display device of FIG. 1 are restricted;

FIG. 9 is a representation of the angular range in which the true Eigen axes of the birefringent element of FIG. 1 are restricted;

FIG. 10 is a representation of the Eigen axes of the display device and the birefringent element of FIG. 1 after deliberate rotation of the birefringent element relative to the display device;

FIG. 11 is a schematic exploded plan view of an optical test system, according to an embodiment of the present disclosure, in which an electronic display device and a birefringent element can be deployed in order to compensate for misalignment between the Eigen axes of the electronic display device and the birefringent element;

FIG. 12 is a schematic representation of a power supply arrangement of the optical test system of FIG. 11, electrically connected to transparent electrodes of the display device;

FIG. 13A illustrates transmission curves for an LCoS, operating in the normally white mode and in the black state, for the case in which no birefringent element is present, and for the case in which the respective Eigen axes of the LCoS and the birefringent element are deliberately misaligned (as in FIG. 10) and electronically compensated;

FIG. 13B illustrates contrast ratio curves of an image produced by the LCoS, for the case in which no birefringent element is present, and for the case in which the respective Eigen axes of the LCoS and the birefringent element are deliberately misaligned (as in FIG. 10) and electronically compensated;

FIG. 14 is a block diagram illustrating an implementation of the optical test system of FIG. 11 as part of a closed loop system that includes a control unit, according to embodiments of the present disclosure;

FIG. 15 is a block diagram of an exemplary control unit of the closed loop system of FIG. 14;

FIG. 16 is a flow diagram illustrating a process for deliberately misaligning the respective Eigen axes of a display device and a birefringent element and electronically compensating for the deliberate misalignment, according to embodiments of the present disclosure;

FIG. 17 is a flow diagram illustrating sub-steps of the process corresponding to FIG. 16 for determining a compensation voltage at which the deliberate misalignment is electronically compensated, according to embodiments of the present disclosure;

FIG. 18 is a schematic exploded plan view of an image projecting optical device, having an electronic display device and a birefringent element with respective Eigen axes deliberately misaligned and for which the deliberate misalignment has been electronically compensated, according to an embodiment of the present disclosure; and

FIG. 19 is a schematic plan view of an optical device including the image projecting optical device of FIG. 18 coupled to a light-waves transmitting substrate, according to an embodiment of the present disclosure.

### DESCRIPTION OF THE PREFERRED EMBODIMENTS

The present invention is directed to methods, system and devices that electronically compensate for the misalignment of an optical element, in particular a birefringent element, with a liquid-crystal-based electronic display device.

The principles and operation of the optical devices and systems according to present invention may be better understood with reference to the drawings accompanying the description.

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways. Initially, throughout this document, references are made to directions such as, for example, top and bottom, clockwise and counter clockwise, and the like. These directional references are exemplary only to illustrate the invention and embodiments thereof.

By way of introduction, liquid-crystal-based electronic display devices, such as LCoS and LCD, harness the optical properties of liquid crystals, in particular birefringent (polarization) properties, to enable control of the brightness of the image pixels displayed by the electronic display device. The liquid crystal material has properties that enable the material to assume a continuum of states that are intermediate between liquid and solid, and that can be used to alter the polarization (i.e., phase) of incident light passing through the liquid crystals. The liquid crystal material regulates the amount of polarized light passing through the liquid crystal in accordance with the state of the liquid crystal material, which can be electronically controlled to change the state assumed by liquid crystals by varying the electric field applied to the liquid crystal material. In this way, the liquid crystal material behaves as a gate or valve that controls the amount light emitted by the display device.

Many liquid-crystal-based display devices take advantage of the twisted nematic (TN) effect, which is based on the precisely controlled realignment of liquid crystal molecules between different ordered molecular configurations under the action of an applied electric field. When little or no electric field is applied, a twisted configuration (resembling a helical structure or a helix) of nematic liquid crystal molecules is formed. As the magnitude of the electric field that is applied to the liquid crystal is increased, the liquid crystal molecules depart from the twisted configuration and move toward an aligned structure. When a maximum electric field is applied, the twisted configuration is broken, and the liquid crystal molecules form the aligned structure.

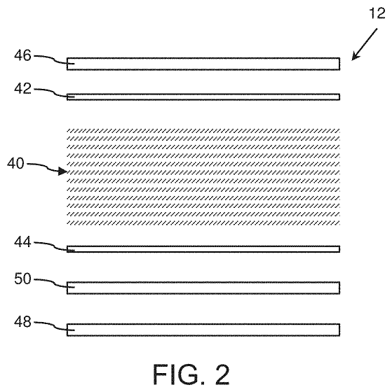

FIG. 2 shows a schematic representation of the display device 12, implemented as a TN LCoS. It is noted that display devices implemented as LCD have similar structure to that of the display device 12, with several modifications as compared to the TN LCoS implementation shown in FIG. 2, as is known to those having skill in the art. Generally speaking, the display device 12 has a layered structure that includes layers of liquid crystal material 40 deployed between two transparent electrodes 42, 44. The transparent electrodes 42, 44 are typically applied on the inward-facing surfaces of a substrate 46, 48, such as glass or quartz, chosen for transparency in the wavelength range of interest, and are possibly overlaid by alignment layers (e.g., directionally-brushed thin layers of polyimide) which maintains the alignment of the liquid crystal material 40. Such alignment layers define the directional alignment of the liquid crystal molecules with respect to the substrate 46, 48. The display device 12 includes a reflective surface 50 that reflects the incoming light to the display device 12 after having passed through the layers of liquid crystal material 40. The reflective surface 50 is deployed below the bottom layer liquid crystal material, for example, between the transparent electrode 44 and the substrate 48. The dimensions (e.g., thickness, width, etc.) of the layers are exaggerated in the drawings for clarity of illustration.

Liquid-crystal-based electronic display devices can operate in various operational modes, two exemplary modes being referred to in the literature as “normally dark mode” and “normally white mode”. In normally dark mode, when little or no voltage (electric field) is applied across the transparent electrodes 42, 44, the display device is considered to be in the “off state”, whereby the liquid crystal material assumes a state (twisted configuration) that, optionally in combination with one or more polarizers, suppresses the light that is emitted by the display device 12 such that any image appears as black. To switch the display device to the “on state” to produce a bright image, an appropriate voltage (V_{white}) is applied across the transparent electrodes 42, 44, whereby the liquid crystal material assumes a different state (aligned configuration) that allows light to pass and birefringence effects of the birefringent element 34 are suppressed, i.e., reduced or minimized, and preferably eliminated. The operation of normally white mode is generally opposite to that of normally dark mode. In other words, the display device is in the “on state” when little to no voltage is applied across the transparent electrodes, and the display device is in the “off state” when an appropriate voltage (V_{black}) is applied across the transparent electrodes (and birefringence effects of the birefringent element 34 are suppressed, i.e., reduced or minimized, and preferably eliminated). The advantage of operating in normally white mode is that little or no voltage is required to produce bright images, thereby significantly reducing the power consumption of the display device 12. In general terms, display devices, particularly microdisplays implemented as LCoS displays configured to operate in “normally white mode”, are preferably used in combination with the family of solutions for HMDs and NEDs commercially available from Lumus Ltd.

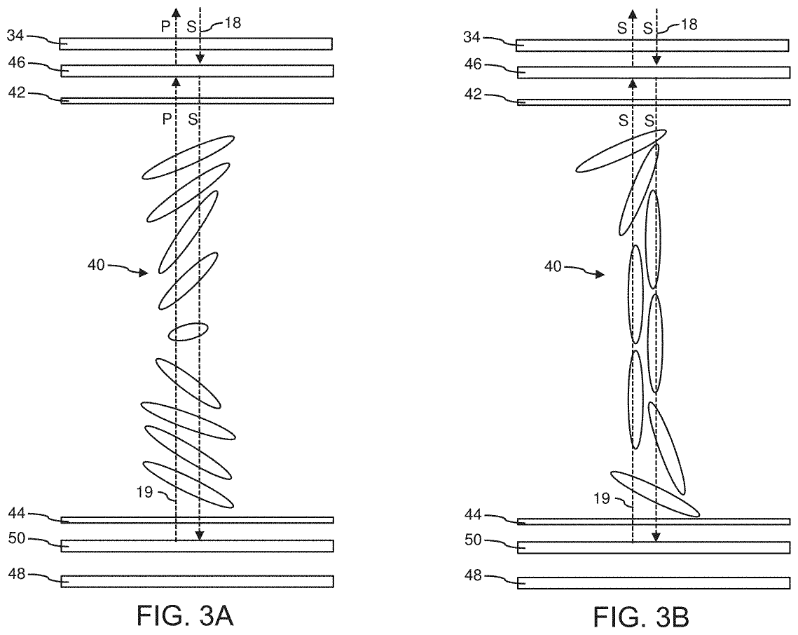

FIGS. 3A and 3B show schematic representations of the traversal of light through the birefringent element 34 and a display device 12, and the polarization effects on the traversing light. The display device 12 in FIGS. 3A and 3B is implemented as a TN LCoS configured to operate in normally white mode, i.e., the display device 12 assumes the “on state” (twisted configuration) when no voltage is applied across the transparent electrodes 42, 44, and the display device 12 assumes the “off state” (aligned configuration) when an appropriate voltage (that reduces/minimizes, and preferably eliminates birefringence effects from the birefringent element 34) is applied across the transparent electrodes 42, 44. Similar to as in FIG. 2, the dimensions (e.g., thickness, width, etc.) of the layers in FIGS. 3A and 3B are exaggerated in the drawings for clarity of illustration.

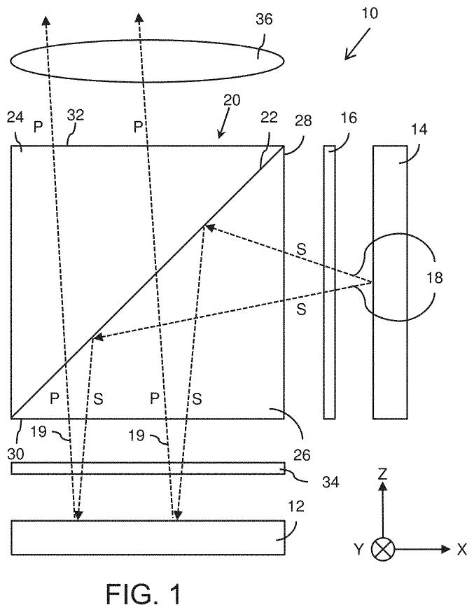

As seen in FIG. 3A, when no voltage (i.e., no electric field) is applied across the transparent electrodes 42, 44, the liquid crystal material 40 maintains its twisted configuration. The polarized incident beam 18 (which in the example shown in FIG. 1 is s-polarization) is transmitted through the birefringent element 34 and into the display device 12, whereupon the light interacts with the layers of liquid crystal material 40. When in the twisted configuration, the liquid crystal material behaves similar to a quarter wave plate (QWP). Each layer of liquid crystal material incrementally rotates the polarization of the beam such that by the time the incident beam 18 reaches the reflective surface 50, the polarization has been rotated relative to the entrance surface of the display device 12. The reflected beam 19 again interacts with the layers of liquid crystal material 40, with each layer of liquid crystal material incrementally rotating the polarization of the beam 19 such that by the time the beam 19 exits the top layer of liquid crystal material, the polarization of the beam 19 is rotated orthogonal to the polarization of the incident beam 18, which in the example in the drawings is p-polarization.

As seen in FIG. 3B, when an appropriate voltage (that reduces/minimizes, and preferably eliminates birefringence effects from the birefringent element 34) is applied across the transparent electrodes 42, 44, the twisted configuration is disrupted such that the majority of the layers of liquid crystal material are substantially aligned with the incoming light beam 18 and behave similar to an isotropic element. As a result, when the polarized incident beam 18 interacts with the layers of liquid crystal material 40, the liquid crystal material performs little to no incremental rotation of the polarization of the beam, and as such, the polarization of the reflected beam 19 is substantially unchanged relative to the polarization of the incident beam 18. Accordingly, the light that is emitted by the display device 12 (in the off state) is reflected by the PBS 22, and therefore is not formed as an image by the collimating optics 36.

The above description of the behavior of light propagation through the layers of liquid crystal material 40, with reference to FIGS. 3A and 3B, is for the ideal case in which the Eigen axes of the of the birefringent element 34 are aligned (either perfectly or within a small prescribed tolerance) with the corresponding Eigen axes of the display device 12. However, as alluded to above, misalignment beyond the prescribed tolerance may result in unwanted slant or skew rays passing through to the collimating optics 36.

Parenthetically, it is noted that as used within the context of this document, the term “perfectly aligned”, with reference to the birefringent element 34 and/or the display device 12, refers to the ideal case in which the respective Eigen axes of the birefringent element 34 and the display device 12 are aligned with each other.

As is known in the art, one of the foremost properties of liquid crystal materials for the phase manipulation of incident light is the birefringence, denoted Δη, which is defined as:

$$Δη = {η}_{e} - {η}_{o} \qquad ( 1 )$$

where ηₒ is the ordinary refractive index for incident light having electric field polarization in a direction that is perpendicular to the director of the layers of liquid crystal material 40, and ηₑ is the extraordinary refractive index for incident light having electric field polarization in a direction that is parallel to the director. The director is generally defined to be the average direction of the long molecular axes of all of the liquid crystal molecules in the layers of liquid crystal material 40.

The accumulated phase retardation between two linear polarizations for incident light passing through the liquid crystal material is expressed as:

$$Γ = Δη \frac{2 π}{λ} d \qquad ( 2 )$$

where λ is the wavelength of the incident light, and d is the thickness of the liquid crystal material (referred to as the cell gap). In LCoS displays the incident light passes through the liquid crystal layer twice (due to reflection from the reflective surface 50), and therefore the effective cell gap is 2d, resulting in an effective doubling of the accumulated phase retardation.

As the magnitude of the electric field applied across the transparent electrodes 42, 44 changes, so does the orientation of the liquid crystal molecules. For an LCoS operating in normally white mode, as the magnitude of the electric field is increased, the liquid crystal material departs from the nominally twisted state (FIG. 3A) and moves toward a more aligned state (FIG. 3B). The change in the state of the liquid crystal material has a direct effect on the extraordinary refractive index ηₑ, which can be expressed as a function of multiple variables, most notably the ordinary refractive index ηₒ and the voltage ν (electric field magnitude) applied across the transparent electrodes 42, 44. Specifically, the extraordinary refractive index ηₑ can be expressed as:

$${η}_{e} = {η}_{o} + \frac{v}{{V}_{max}} * \frac{i λ}{2 d} \qquad ( 3 )$$

where Vₘₐₓ is the maximum voltage (electric field) that can be applied across the transparent electrodes 42, 44. In general, the voltage ν applied across the transparent electrodes 42, 44 can vary continuously between a default minimum voltage Vₘᵢₙ (most typically 0 volts), and a default maximum voltage Vₘₐₓ (for example 3.3 volts). Accordingly, when voltages of Vₘᵢₙ and Vₘₐₓ are applied, the liquid crystal material assumes the first state (i.e., twisted state as in FIG. 3A) and the second state (i.e., aligned state as in FIG. 3B), respectively.

By combining equations (1)-(3), the accumulated phase difference, δ, between the two Eigen polarizations for light propagating back and forth through the layers of liquid crystal material 40, can be expressed as:

$$δ = i π \frac{v}{{V}_{max}} \qquad ( 4 )$$

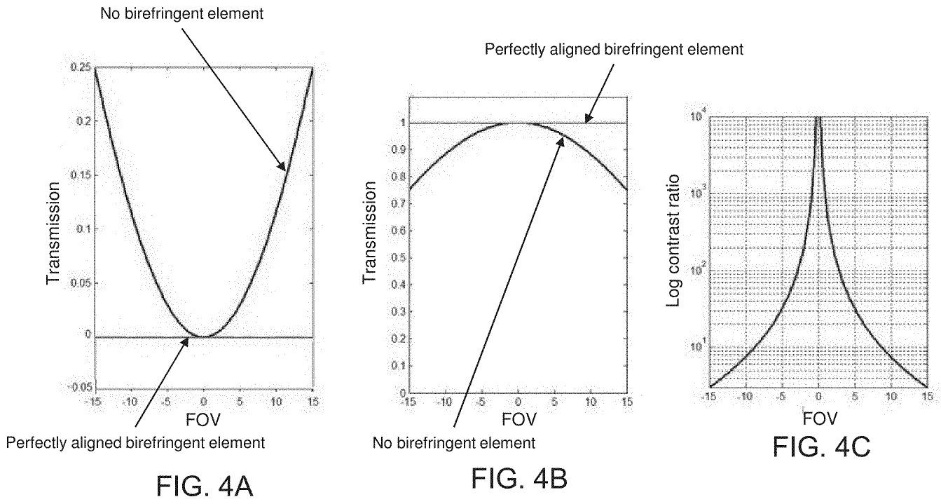

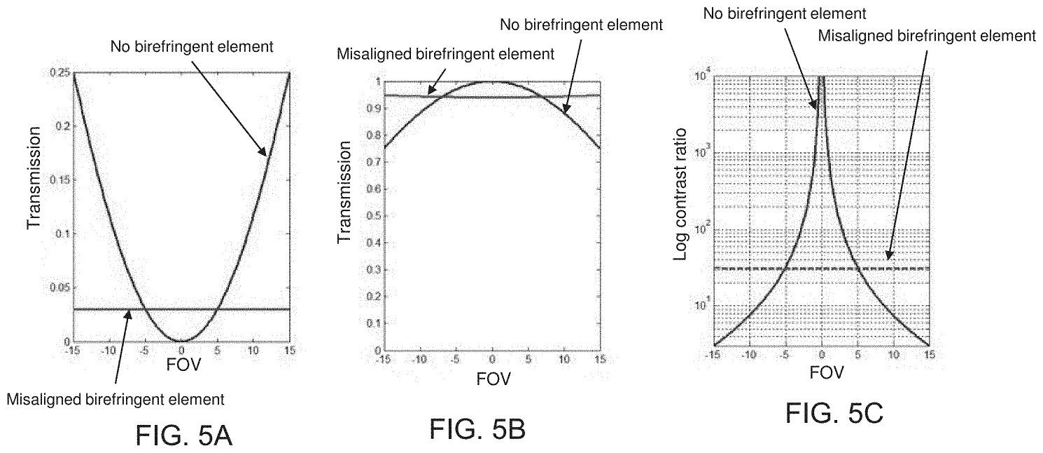

The importance of the birefringent element 34, and the alignment of its Eigen axes with the Eigen axes of the display device 12, is illustrated in FIGS. 4A-5C, which show various transmission and contrast curves from computer simulations associated with the image output by the display device 12. The horizontal axis of each curve represents the field of view (FOV) in degrees for light incident on the PBS 22 in the skewing direction (i.e., coming out of the plane of the paper in FIG. 1). Note that in the computer simulations the PBS 22 is assumed to be an ideal PBS, for example with ideal dielectric coatings, such that s-polarized light is perfectly reflected by the PBS 22 (i.e., R_{S}=1) and p-polarized light is perfectly transmitted by the PBS 22 (i.e., T_{P}=1). It is also noted that the birefringent element 34 is also assumed to be an ideal optical element, being isotropic across the FOV and wavelengths of light.

FIG. 4A shows two overlaid transmission curves for the scenario in which a voltage of V_{black} is applied across the transparent electrodes 42, 44 so as to operate the display device 12 in a black state (also referred to as dark state), i.e., minimal light propagation passing through the PBS 22 from the display device 12. The voltage V_{black} may be equal to, or approximately equal to, Vₘₐₓ if the display device 12 operates in “normally white mode” (i.e., for an LCoS operating in normally white mode, the LCoS assumes the black state at voltage V_{black}≈Vₘₐₓ). Parenthetically, throughout the remainder of this document, and without loss of generality, the voltage required to operate a normally white display device 12 in the black state is considered to be the same as the maximal voltage that can be applied across the transparent electrodes (i.e., V_{black}=Vₘₐₓ), and therefore, the voltages V_{black} and Vₘₐₓ may be used interchangeably. However, it should be noted that other configurations are possible in which V_{black}≠Vₘₐₓ.

Referring again to FIG. 4A, one of the transmission curves shows the case in which the birefringent element 34 is absent from the image projector 10. The other transmission curve shows the case in which the birefringent element 34 is included and the Eigen axes of the display device 12 and the birefringent element 34 are perfectly aligned. As can be seen in in FIG. 4A, when the display device 12 operates in the black (dark) state without the birefringent element 34, the light waves emitted by the display device 12 have transmission that is parabolic across the FOV, with minimal (zero) transmission at FOV=0. When the display device 12 operates in the black (dark) state with a perfectly birefringent element 34, the light waves emitted by the display device 12 have minimal (zero) transmission across the FOV. As such, the birefringent element 34, when perfectly aligned with the display device 12, plays a significant role in suppressing the transmission of light for skew/slant beams.

FIG. 4B shows two overlaid transmission curves for the scenario in which a voltage of V_{white} is applied across the transparent electrodes 42, 44 so as to operate the display device 12 in a white state (also referred to as light state), i.e., maximal light propagation passing through the PBS 22 from the display device 12. The voltage V_{white} may be equal to, or approximately equal to, Vₘᵢₙ if the display device 12 operates in “normally white mode”. Parenthetically, throughout the remainder of this document, and without loss of generality, the voltage required to operate a normally white display device 12 in the white state is considered to be the same as the minimal voltage that can be applied across the transparent electrodes (i.e., V_{white}=Vₘᵢₙ), and therefore, the voltages V_{white} and Vₘᵢₙ may be used interchangeably. However, it should be noted that other configurations are possible in which V_{white}≠Vₘᵢₙ.

Referring again to FIG. 4B, one of the transmission curves shows the case in which the birefringent element 34 is absent from the image projector 10. The other transmission curve is for the case in which the birefringent element 34 is included and the Eigen axes of the display device 12 and the birefringent element 34 are perfectly aligned. As can be seen in in FIG. 4B, when the display device 12 operates in the white (light) state without the birefringent element 34, the light waves emitted by the display device 12 have transmission that is parabolic across the FOV, with maximal (one) transmission at FOV=0. When the display device 12 operates in the white (light) state with a perfectly birefringent element 34, the light waves emitted by the display device 12 have maximal (one) transmission across the FOV.

FIG. 4C shows the logarithm of the contrast ratio (i.e., a log contrast ratio curve) of the image produced by the display device 12 in the absence of the birefringent element 34, i.e., the ratio between the brightness of the image in the black state (FIG. 3A) and the white state (FIG. 3B). As can be seen, the contrast exponentially approaches infinity as the FOV approaches zero. Although not shown in FIG. 4C, the contrast ratio for the case in which the birefringent element 34 is perfectly aligned with the display device 12 should be sufficiently large (on the order of >3000:1) across the entire FOV.

FIGS. 5A-5C show curves for scenarios similar to those discussed with reference to FIGS. 4A-4C, except that instead of a perfectly aligned birefringent element 34, the Eigen axes of the birefringent element 34 are misaligned with the Eigen axes of the display device 12 by 5 degrees (˜0.0873 radians). As can be seen in FIG. 5A, the misalignment leads to an unwanted leakage of light for skew/slant beams across the entire FOV. Quantification of the unwanted transmission of light can be approximated using the 4θ² leakage approximation discussed in the background section of this document. For a misalignment of ˜0.0873 radians, the expected leakage is approximately 4*(0.0873)²≈0.03, which is the transmission depicted in the simulation results in FIG. 5A. The misalignment little to no effect in the scenario in which the display device 12 operates in the white state (other than a slight drop in transmission), as can be seen in FIG. 5B. However, due to the aforementioned leakage, the misalignment has a significant effect on the contrast ratio. As can be seen in FIG. 5C, the contrast ratio remains constantly low (approximately 30:1) across the entire FOV.

Embodiments of the present disclosure describe steps for compensating for misalignment between the respective Eigen axes (referred to interchangeably as polarization axes) of the display device 12 and the birefringent element 34. The proposed method relies on deliberately misaligning the aforementioned Eigen axes and electronically compensating for the misalignment by exploiting the underlying link between the rotation in polarization caused by the misalignment and the accumulated phase difference δ of light propagating through the layers of liquid crystal material 40, as outlined above with reference to equations (1)-(4).

Initially, the birefringent element 34 and the display device 12 are deliberately misaligned in a prescribed direction, in order to ensure that the alignment error is positive, and within a prescribed amount based on the tolerances of the Eigen axes of the birefringent element 34 and the display device 12. The deliberate misalignment is preferably performed mechanically using a mechanical alignment methodology generally known to those of skill in the art. Subsequent to the deliberate misalignment, steps are executed to determine a compensation voltage V_{c} (between Vₘᵢₙ and Vₘₐₓ), that when applied across the transparent electrodes 42, 44, causes the layers of liquid crystal material 40 to assume an intermediate state such that the accumulated phase difference δ of polarized light passing through the layers of liquid crystal material 40 results in the image produced by the electronic display source 12 having sufficient image quality (as determined by an image quality metric or metrics). In particular, the layers of liquid crystal material 40 assume the intermediate state at the compensation voltage V_{c} such that the electronic display device 12 produces polarized image light waves having polarization in a polarization direction that is in accordance with the intermediate state and that compensates for the deliberate misalignment (i.e., rotational offset) between the Eigen axes of the electronic display device 12 and the birefringent element 34.

Parenthetically, it is noted herein that the term “intermediate state” generally refers to any state in a continuum of states, that can be assumed by the layers of liquid crystal material 40, that is between the two extreme states assumed in response to application of voltages Vₘᵢₙ and Vₘₐₓ, exemplified, for example, as the twisted state and aligned state illustrated in FIGS. 3A and 3B, respectively.

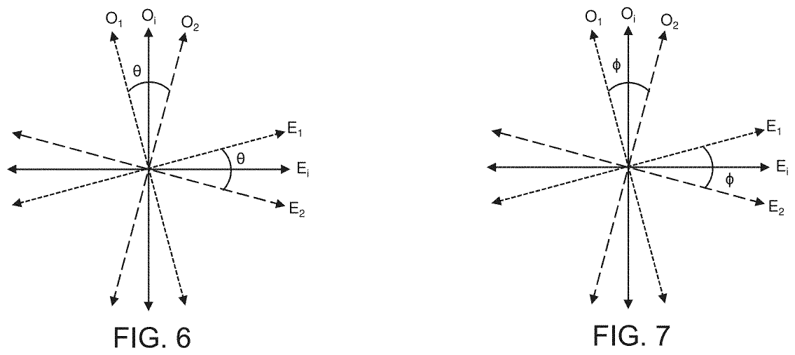

The following paragraphs describe steps for the deliberate misalignment of the birefringent element 34 and the display device 12. Referring to FIG. 6, the ideal Eigen axes Eᵢ and Oᵢ of the display device 12 are shown. The ideal Eigen axes represent the ideal effective Eigen axes of the display device 12 defined by the layers of liquid crystal material 40. Due to imperfections and precision limitations in the design and manufacturing process of the display device 12, deviations from the ideal Eigen axes within an accepted tolerance amount are expected. As seen in FIG. 6, the tolerance amount is depicted as a rotational offset of θ, wherein the display device 12 may have its true ordinary Eigen axis anywhere between O₁ and O₂, and its true extraordinary Eigen axis anywhere between E₁ and E₂. The boundary axes (O₁, O₂) and (E₁, E₂) define an angular offset range of θ due to counter clockwise and clockwise rotation from the ideal Eigen Eᵢ, axes Oᵢ. Therefore, although the true Eigen axes of the display device 12 are difficult, if not impossible, to ascertain, the position of the true Eigen axes can be restricted to an angular region defined by the expected tolerance θ.

Referring now to FIG. 7, the ideal Eigen axes Eᵢ and Oᵢ of the birefringent element 34 are shown. Similar to as in FIG. 6, imperfections and precision limitations in the design and manufacturing process of the birefringent element 34 yields deviations from the ideal Eigen axes within an accepted tolerance amount. As seen in FIG. 7, the tolerance amount is depicted as a rotational offset of ϕ, wherein the birefringent element 34 may have its true ordinary Eigen axis anywhere between O₁ and O₂, and its true extraordinary Eigen axis anywhere between E₁ and E₂. The boundary axes (O₁, O₂) and (E₁, E₂) define an angular offset range of ϕ due to counter clockwise and clockwise rotation from the ideal Eigen axes Eᵢ, Oᵢ. Therefore, although the true Eigen axes of the birefringent element 34 are difficult, if not impossible, to ascertain, the position of the true Eigen axes can be restricted to an angular region defined by the expected tolerance θ.

In certain implementations, the expected tolerances θ and ϕ may be the same. In other implementations, the expected tolerances θ and ϕ are different.

In practice, the birefringent element 34 is coupled to the display device 12, for example via a mechanical body, to form a unitary display module. The mechanical body maintains the position of the birefringent element 34 and the display device 12, and as such maintains the orientation of the Eigen axes of the birefringent element 34 and the display device 12. Prior to coupling the birefringent element 34 and the display device 12 together, the birefringent element 34 and the display device 12 are relatively deployed such that Eigen axes of the birefringent element 34 and the display device 12 are deliberately rotationally offset from each other in a prescribed direction such that the angle between the respective Eigen axes of the birefringent element 34 and the display device 12 is positive and is within a maximum tolerance of τ=θ+ϕ (where τ=2θ in the case of θ=ϕ).

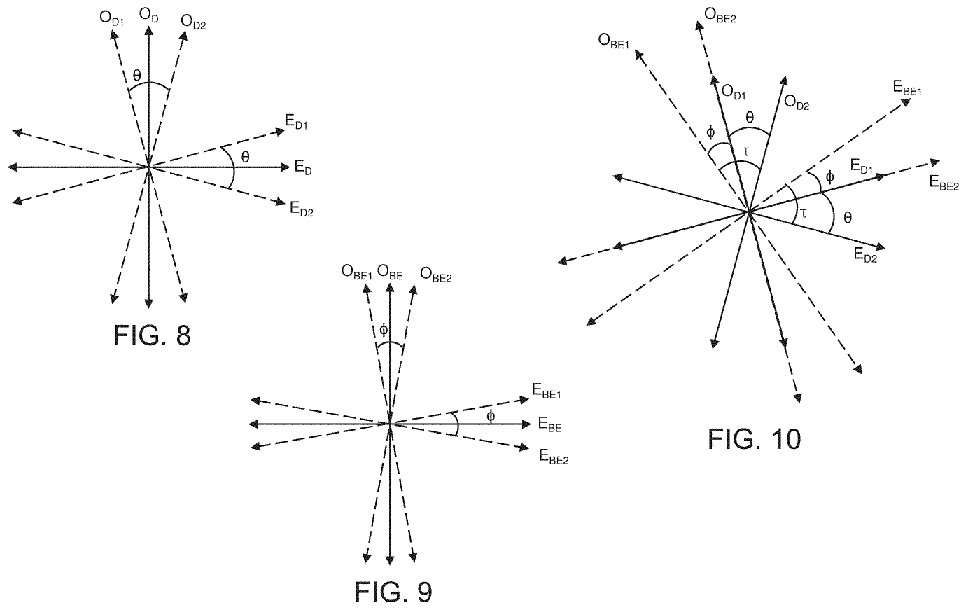

FIG. 8 shows the angular range of θ in which the true Eigen axes of the display device 12, labeled as E_{D} and O_{D}, are restricted. The true Eigen axes E_{D} and O_{D} are bounded by E_{D1}, E_{D2} and O_{D1}, O_{D2}, respectively. FIG. 9 shows the angular range of ϕ in which the true Eigen axes of the birefringent element 34, labeled as E_{BE} and O_{BE}, are restricted. The true Eigen axes E_{BE} and O_{BE} are bounded by E_{BE1}, E_{BE2} and O_{BE1}, O_{BE2}, respectively. The exact position of the Eigen axes (E_{BE}, O_{BE}) and (E_{D}, O_{D}) are generally unknown, as discussed above, but are provided within a range bounded by the given tolerance values θ and ϕ. Therefore, when provided with the tolerance values θ and ϕ, the birefringent element 34 and the display device 12 can be rotated relative to each other, about the axis coming out of the plane of the paper in FIGS. 8 and 9 (which is the Z-axis in FIG. 1), such that the angle between the respective Eigen axes of the birefringent element 34 and the display device 12 is positive and is within the maximum tolerance τ. In order to achieve the angular offset between the respective Eigen axes of the birefringent element 34 and the display device 12, the birefringent element 34 is rotated relative to the display device 12 such that the angle between the boundary ordinary axis of the birefringent element 34 (O_{BE1}) and the boundary ordinary axis of the display device 12 (O_{D1}) is equal to ϕ (positive). In the illustrated example, the arbitrary orientation dictates counter clockwise rotation of the birefringent element 34 by an angle of ϕ.

FIG. 10 illustrates the Eigen axes of the birefringent element 34 and the display device 12 after counter clockwise rotation of the birefringent element 34 by an angle of ϕ. As a result of this rotation, the angular offset between the ordinary axes of the birefringent element 34 and the display device 12 is restricted to a range between 0 and τ. A minimum angular offset of 0, between the ordinary axes of the birefringent element 34 and the display device 12, is achieved when the true ordinary axis of the birefringent element 34 is on the boundary O_{BE2} and the true ordinary axis of the display device 12 is on the boundary O_{D1}. A maximum angular offset of r, between the ordinary axes of the birefringent element 34 and the display device 12, is achieved when the true ordinary axis of the birefringent element 34 is on the boundary O_{BE1} and the true ordinary axis of the display device 12 is on the boundary O_{D2}.

Note that since the ordinary and extraordinary axes are orthogonal axes, the rotational offset between the ordinary axes of the birefringent element 34 and the display device 12 is the same as the rotational offset between the extraordinary axes of the birefringent element 34 and the display device 12. Therefore, the aforementioned rotation results in an angle of ϕ between the boundary extraordinary axis of the birefringent element 34 (E_{BE1}) and the boundary extraordinary axis of the display device 12 (E_{D1}).

Once the birefringent element 34 and the display device 12 are rotationally offset from each other within the prescribed offset amount in the prescribed offset direction, the birefringent element 34 is coupled (i.e., attached) to the display device 12 to form the unitary display module.

Generally speaking, the birefringent element 34 and the display device 12 may be substantially rectangular in the XY plane (with reference to the arbitrary coordinate system of FIG. 1). The rotational offset may be performed during the manufacturing process of the either or both of the birefringent element 34 and the display device 12, i.e., during the forming of the unitary display module, whereby the birefringent element 34 may be cut such that when the rectangular planar surfaces of the birefringent element 34 and the display device 12 are aligned with each other, the Eigen axes of the birefringent element 34 are rotationally offset from the Eigen axes of the display device 12 (by the requisite amount and in the requisite direction).

As mentioned above, subsequent to the deliberate misalignment of the birefringent element 34 and the display device 12, steps are executed to determine the compensation voltage V_{c} (between Vₘᵢₙ and Vₘₐₓ) at which the image generated by the unitary display module (with the deliberately misaligned birefringent element 34) has the same or similar image quality (determined by contrast ratio or other relevant image quality metric or metrics) as an image generated at V_{black} with a perfectly aligned birefringent element 34. The following paragraphs describe the steps for determining the compensation voltage V_{c}.

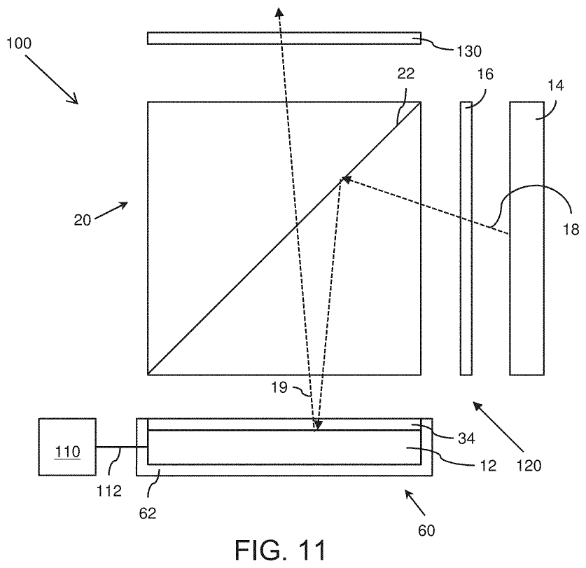

FIG. 11 schematically illustrates an optical test system, generally designated 100, and referred to hereinafter as system 100, that is used to electronically compensate for the deliberate misalignment between the birefringent element 34 and the display device 12. Generally speaking, the system 100 includes a power supply arrangement 110, an optical arrangement 120, and an image analyzer 130. The unitary display module, generally designated 60, having the rotationally offset birefringent element 34 and display device 12 coupled to each other via a mechanical body 62, is deployed relative to the optical arrangement 120. In embodiments in which the display device 12 is implemented as an LCoS, the optical arrangement 120 includes the illumination components of the image projecting optical arrangement 10 of FIG. 1, namely the source of polarized light (i.e., the light source 14 and the linear polarizer 16) and the illumination prism 20. Note that other embodiments are contemplated in which the display device 12 is implemented as an LCD. In such embodiments, modifications to the optical test system are applied to provide an optical test system configuration suitable for use with LCD devices. Such modification may include, for example, deploying a source of polarized light (that may be implemented as combination of a light source, for example a light emitting diode (LED), with a linear polarizer) at the input to the LCD device.

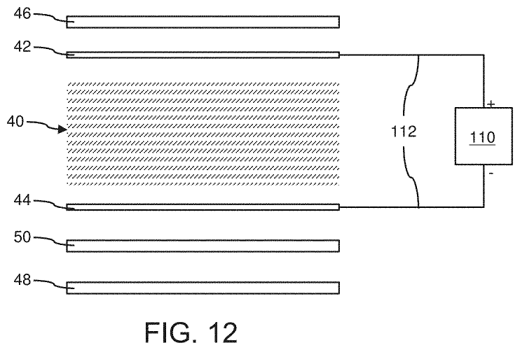

The power supply arrangement 110 is electrically coupled to the display device 12 via an electrical connection arrangement 112. The power supply arrangement 110 can be implemented as a voltage source configured to output a voltage (that can be selected from a range of voltages between Vₘᵢₙ and Vₘₐₓ and set by a human operator of the system 100 or by a hardware controller) that is to be applied across the transparent electrodes 42, 44. In such an implementation, the electrical connection arrangement 112 can be implemented, for example, as a set of leads, with one lead extending from a positive terminal of the voltage source to one of the transparent electrodes 42, 44 and another lead extending from a negative terminal of the voltage source to the other of the transparent electrodes 42, 44. Such an implementation is schematically illustrated in FIG. 12.

The image analyzer 130 is deployed to receive image light waves emitted by the display module 60 in response to illumination by the source of polarized light. Specifically, the image analyzer is 130 is configured to receive the spatial modulation of (reflected) light (from the source of polarized light), corresponding to an image, generated by the display device 12 of the display module 60. Light from the source of polarized light follows a similar path of traversal as that described with reference to FIG. 1, but the image light waves output from the display module 60 are captured by the image analyzer 130 following transmission through the illumination prism 20. Specifically, incident beam 18 enters the illumination prism 20 with a first polarization, typically an s-polarization relative to the PBS 22, and is reflected towards the display module 60 where it impinges on the display device 12. Pixels corresponding to bright regions of the image are reflected with modulated rotated polarization (typically p-polarization), so that the reflected beam 19 from the bright pixels is transmitted through the PBS 22 and reaches the image analyzer 130.

The image analyzer 130 may include at least one computerized processor coupled to a storage medium (such as a memory or the like). The image analyzer 130 is further configured to evaluate one or more image quality metric of the image produced by the display module 60, and in certain preferred but non-limiting implementations is configured to evaluate the contrast ratio of the images produced by the display module 60. The image analyzer 130 can be implemented as part of a computer system that includes a display for displaying the aforesaid image quality metric(s), such that when the system 100 is operated by a human operator in an optical test environment, the human operator may visually perceive the image quality metric(s) displayed by the computer system.

As the voltage output by the power supply arrangement 110 is varied between Vₘᵢₙ and Vₘₐₓ, the state assumed by the layers of liquid crystal material 40 also changes. The change in state of the layers of liquid crystal material 40 effects the accumulated phase difference δ of light propagating through the layers of liquid crystal material 40, and as a result, directly effects the brightness of the reflected beam 19. At some point, the voltage output reaches a compensation voltage V_{c} that causes the layers of liquid crystal material 40 to assume an intermediate state which effects the polarization of light passing therethrough in a way that results in an output image having contrast ratio that is the same or similar to that of an output image that is the result of the layers of liquid crystal material 40 assuming a state at voltage V_{black} when the birefringent element 34 is perfectly aligned.

Looking again at equation (4), it is clear that the accumulated phase difference δ is a function of the voltage ν applied across the transparent electrodes 42, 44, and in particular is proportional to the voltage ν applied across the transparent electrodes 42, 44. Therefore, by adjusting the voltage ν applied across the transparent electrodes 42, 44 in proportion to the deliberate misalignment angle, the layers of liquid crystal material 40 assume an intermediate state such that the display device 12 compensates for the change in polarization of light passing through the liquid crystal material induced by the misalignment of the birefringent element 34. In effect, if the deliberate misalignment angle is measured as ϕ degrees, the compensation voltage V_{c} that is required to compensate for the deliberate misalignment of the birefringent element 34 can be expressed as:

$${V}_{c} = {V}_{black} \frac{180 - 2 ϕ}{180} \qquad ( 5 )$$

Since the exact misalignment angle ϕ is unknown (due to the variability of the true Eigen axes of the birefringent element 34 and the display device 12), the compensation voltage V_{c} is also unknown. However, the compensation voltage V_{c} can be determined by adjusting the voltage applied across the transparent electrodes 42, 44 (via the power supply arrangement 110), while simultaneously evaluating the image quality metric(s), until the image quality metric(s) satisfy corresponding performance criteria (e.g., until the contrast ratio is deemed to be high enough). At that point, the voltage output by the power supply arrangement 110 is determined to be the compensation voltage V_{c}. Furthermore, once the compensation voltage V_{c} is determined, the misalignment angle ϕ can be estimated as

$$ϕ = 90 ( 1 - \frac{{V}_{c}}{{V}_{black}} ) .$$

As see from equation (5), the compensation voltage V_{c} is a proportionally reduced version of V_{black}, in particular V_{black} is reduced by an amount of

$$\frac{2 ϕ}{180}$$

in order to achieve V_{c}.

Continuing with the numerical example of a deliberate misalignment of 5 degrees described with reference to FIGS. 5A-5C, the compensation voltage V_{c} required to compensate for the misalignment is

$${V}_{c} = {V}_{black} \frac{180 - 2 * 5}{180} = {V}_{black} ( \frac{170}{180} ) .$$

Accordingly, the compensation voltage V_{c} is achieved by reducing V_{black} by

$$\frac{2 * 5}{180} = \frac{10}{180} \approx 5.55 \% .$$

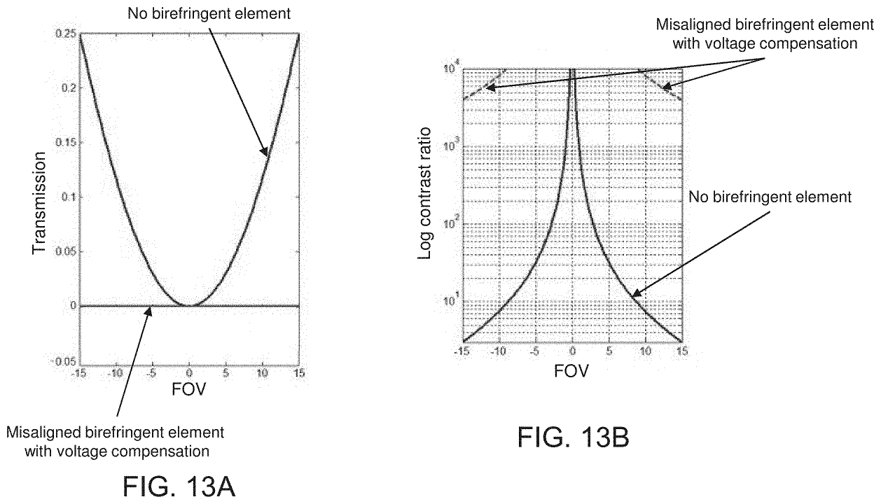

FIGS. 13A and 13B show curves for scenarios similar to those discussed with reference to FIGS. 4A-5C, except that curves are shown for the case in which the birefringent element 34 is deliberately misaligned by 5 degrees and a voltage of

$${V}_{th} = {V}_{black} ( \frac{170}{180} )$$

is applied across the transparent electrodes 42, 44 so as to compensate for the deliberate misalignment. As can be seen in FIG. 13A, when the voltage V_{c} is applied, the light waves emitted by the display module 60 have minimal (zero) transmission across the FOV, similar, if not identical, to the case in FIG. 4A in which the display device 12 operates in the black (dark) state (i.e., a voltage of V_{black} is applied across the transparent electrodes 42, 44 with a perfectly birefringent element 34). Furthermore, as previously discussed with reference to FIG. 5B, since the misalignment of the birefringent element 34 has little to no effect on the transmission of light when the display device 12 operates in the white state (other than a slight drop in transmission), the voltage compensation has no effect on the transmission of light in the white state. However, the application of voltage V_{c} across the transparent electrodes 42, 44 has a significant effect on the contrast ratio, which as can be seen from FIG. 13B, is significantly high across the entire FOV, with a minimum value of approximately 4000:1 at the edges of the FOV, and approaching infinity as the FOV approaches zero.

According to certain embodiments of the present disclosure, the voltage output by the power supply arrangement 110 is electronically adjusted in response to actuation/operation of the power supply arrangement 110 by a human operator of the system 100. In such embodiments, the human operator of the system 100 may manually actuate/operate the power supply arrangement 110 to output a desired voltage while visually inspecting the image quality metric(s) until the image quality metric(s) satisfy corresponding performance criteria. In other embodiments, the optical test system is implemented as part of a closed loop system with feedback, so as to enable the automated adjustment of the output voltage of the power supply arrangement 110 until the requisite performance criterion (or criteria) are satisfied.

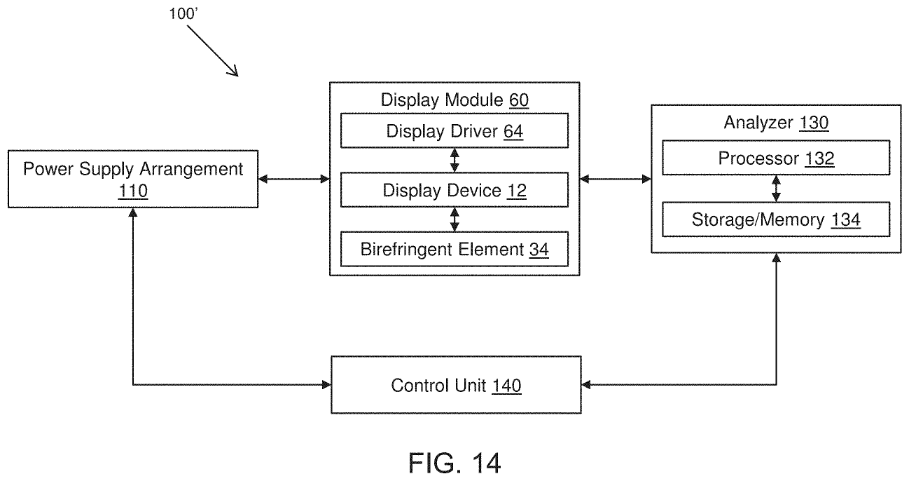

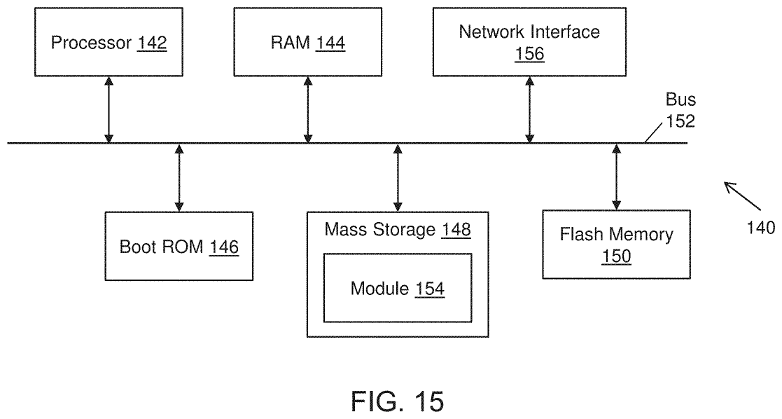

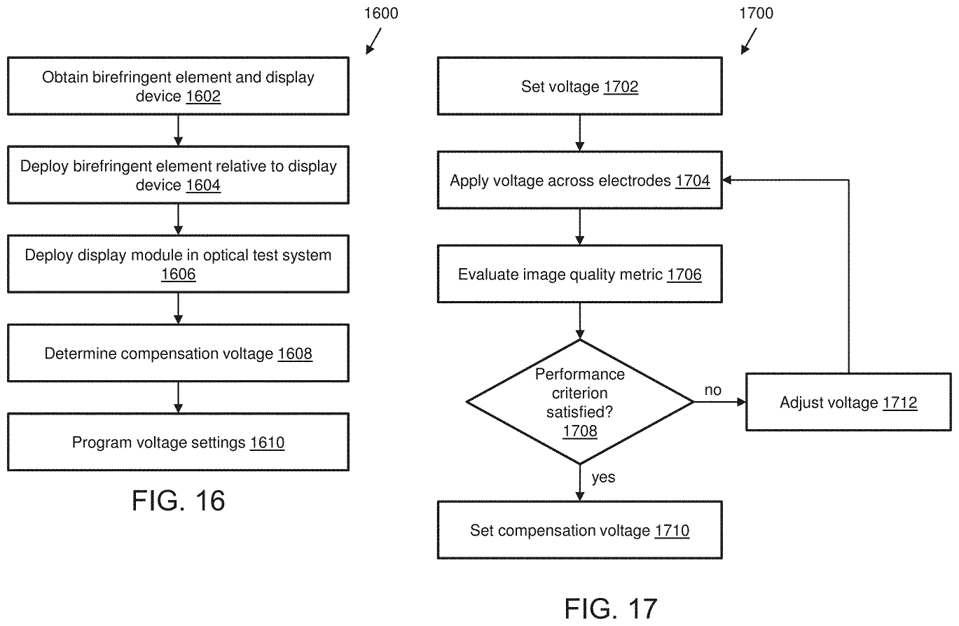

FIG. 14 shows a generalized block diagram of such a closed loop system 100′, according to an embodiment of the present disclosure. As can be seen, the closed loop system 100′ includes a control unit 140 that is connected to the power supply arrangement 110 and the image analyzer 130. The illustrated connection between the image analyzer 130 and the display module 60 in FIG. 14 represents the capability of the image analyzer 130 to receive the image light waves emitted by the display module 60. The desired contrast ratio (or any other image quality metric performance criterion) may be programmed into a memory of the control unit 140 (for example, one of the exemplary memory devices shown in FIG. 15). The control unit 140 may then actuate the power supply arrangement 110 to output an initial set voltage that is applied across the transparent electrodes 42, 44. The image analyzer 130 determines the contrast ratio (as previously discussed), and provides the determined contrast ratio to the control unit 140. The control unit 140 then compares the determined contrast ratio with the desired contrast ratio, and, if the determined contrast ratio is too small, the control unit 140 actuates the power supply arrangement 110 to output an adjusted voltage (i.e., a voltage that is different from the initial voltage, e.g., stepped up or stepped down from the set output voltage by an incremental amount) that is applied across the transparent electrodes 42, 44. This process is repeated until the determined contrast ratio is greater than or equal to the desired contrast ratio. At that point, the control unit 140 may store the voltage output by the power supply arrangement 110 as the compensation voltage V_{c}.

Refer now to FIG. 15, a high-level partial block diagram of an exemplary control unit 140 configured to implement the control functionality described above with reference to FIG. 14. The control unit 140 includes one or more processor 142 and four exemplary memory devices: a random access memory (RAM) 144, a boot read-only memory (ROM) 146, a mass storage device (e.g., a hard disk) 148, and a flash memory 150, all connected or linked to each other (electronically and/or data), either directly or indirectly, for example via a common bus 152. As is known, processing and memory can include any computer readable medium storing software and/or firmware and/or any hardware element(s) including but not limited to field programmable logic arrays (FPLA) element(s), hard-wired logic element(s), field programmable gate array (FPGA) elements(s), and application specific integrated circuit (ASIC) element(s). Any instruction set architecture may be used in the processor 142, including, but not limited to, reduced instruction set computer (RISC) architecture and/or complex instruction set computer (CISC) architecture. The processor 142 can be any number of computer processors, including, but not limited to, microprocessors, microcontrollers, application specific integrated circuits (ASICs), digital signal processors (DSPs), and state machines. A module (processing module) 154 is shown on the mass storage device 148, but as should be understood, could be located on any of the memory devices.

The mass storage device 148 is a non-limiting example of a non-transitory computer-readable (storage) medium bearing computer-readable code for implementing the compensation methodology functionality described herein. Other examples of such computer-readable (storage) media include read-only memories such as, for example, compact disks (CDs) bearing such code. The control unit 140 may have an operating system stored on the memory devices, the boot ROM 146 may include boot code for the operating system, and the processor 142 may be configured for executing the boot code to the load the operating system to the RAM 144, executing the operating system to copy computer-readable code to the RAM 144 and execute the copied computer-readable code. The operating system may include any conventional computer operating systems, such as iOS available from Apple of Cupertino, Calif., and Android available from Google of Mountain View, Calif., or may be implemented as a real-time operating system (RTOS).

The control unit 140 may include a network connection 156 that provides communication (e.g., data communication) to and from the control unit 140. Typically, a single network connection provides one or more links, including virtual connections, to other devices on local and/or remote networks. Alternatively, the control unit 140 can include more than one network connection (not shown), each network connection providing one or more links to other devices and/or networks. Alternatively, the control unit 140 can include an additional data bus to provide communication and data exchange functionality between the control unit 140 and external devices.

Returning to FIG. 14, as previously mentioned, the image analyzer 130 may include a processor 132 coupled to a storage/memory 134. The processor 132 may be implemented as any number of computer processors, including, but not limited to, microprocessors, microcontrollers, application specific integrated circuits (ASICs), and digital signal processors (DSPs). Such processors include, or may be coupled to, non-transitory computer readable media, which stores program code or instruction sets that, when executed by the processor, cause the processor to perform actions. Types of non-transitory computer readable include, but are not limited to, electronic, optical, magnetic, or other storage (e.g., memory) or transmission devices capable of providing a processor with computer readable instructions or instruction sets.

In certain embodiments, the image analyzer 130 may be implemented together with the control unit 140 as part of a single control and processing system executed on a single computer system. In such embodiments, the computer system may include a display that displays various outputs to a human operator of the system 100′. The displayed outputs may include, for example, the determined compensation voltage V_{c}, the various intermediate voltages applied across the transparent electrodes 42, 44, and the corresponding determined contrast ratios (or other image quality metric values). In embodiments in which the image analyzer 130 is not used with the closed loop system 100′, but rather is used as described with reference to FIG. 11 (i.e., the system 100), the image analyzer 130 may still be implemented as part of a computer system having a display that displays the corresponding determined contrast ratios (or other image quality metric values) to a human operator of the system 100.

Attention is now directed to FIG. 15, which shows a flow diagram detailing a process (method) 1600 in accordance with embodiments of the present disclosure. The process 1600 includes steps for compensating for the misalignment of the birefringent element 34. Reference is also made to FIGS. 1-14. Some of the sub-processes of the process 1600 may be performed using mechanical devices and/or assemblies, while other sub-processes of the process 1600 may be performed using computerized components (e.g., computer processors). In addition, some of the sub-processes of the process 1600 may be performed automatically or manually.

The process begins at block 1602, by obtaining the birefringent element 34 and the display device 12. At block 1604, the birefringent element 34 and the display device 12 are deployed relative to each other. The deployment includes the sub-step of deliberately misaligning the birefringent element 34 relative to the display device 12 such that the respective polarization axes (i.e., Eigen exes, i.e., ordinary and extraordinary axes) of the birefringent element 34 and the display device 12 are rotationally offset from each other in a prescribed direction and within a prescribed amount in accordance with the tolerances of the Eigen axes of the birefringent element 34 and the display device 12. The misalignment sub-step may be performed using a mechanical alignment mechanism, for example, an optical alignment mechanism that can be used for passively aligning optical components. The deployment preferably further includes the sub-step of mechanically attaching the misaligned birefringent element 34 to the display device 12, using, for example a mechanical body, to form the unitary display module 60.

The process 1600 then moves to block 1606, where the display module 60 is deployed in the optical test system 100. Block 1606 includes the sub-step of positioning the display module 60 relative to the optical arrangement 120 (e.g., illumination prism 20 and source of polarized light in the configuration of the optical test system in which the display device 12 is implemented as an LCoS) such that image light waves emitted by the display module 60 traverse the optical arrangement 120 and are received at the image analyzer 130. Block 1606 further includes the sub-step of connecting the power supply arrangement 110 to the display module 60.

After the display module 60 is deployed in the optical test system 100, the process 1600 moves to block 1608, where the compensation voltage V_{c}, output by the power supply arrangement 110 and applied across the transparent electrodes 42, 44, is determined. The compensation voltage V_{c} is the voltage that, when applied across the transparent electrodes 42, 44, induces the layers of liquid crystal material 40 to assume an intermediate state that causes the display device 12 to generate spatial modulation of polarized light that passes through the liquid crystal material (the polarized light corresponding to an image), so as to produce polarized image light waves having polarization in a specific polarization direction that is in accordance with the state of the liquid crystal material and that compensates for the rotational offset. In particular, the layers of liquid crystal material 40 assume the intermediate state at the compensation voltage V_{c} such that the electronic display device 12 produces polarized image light waves having polarization in a polarization direction that is in accordance with the intermediate state and that compensates for the deliberate misalignment (i.e., rotational offset) between the Eigen axes of the electronic display device 12 and the birefringent element 34.

As discussed above, when the compensation voltage V_{c} is applied across the transparent electrodes 42, 44 the layers of liquid crystal material 40 assume an intermediate state which effects the polarization of light passing therethrough in a way that results in the output polarized image light waves having contrast ratio that is the same or similar to that of output polarized image light waves that is the result of the layers of liquid crystal material 40 assuming a state at voltage V_{black} when the birefringent element 34 is perfectly aligned

The process 1600 then moves to block 1610, where the voltage settings of a display driver 64 associated with the display device 12 are programmed in accordance with the compensation voltage V_{c} determined in block 1608. The display driver 64 is shown as being part of the display module 60 in FIG. 14, however, it is noted that the display driver 64 may be mechanically separated from the display module 60 while still being functionally associated with the display device 12. As is known in the art, display drivers (also referred to as driving electronics) are integrated circuits that provide an interface between a processing/control device and a display device, enabling the processing/control device to issue command signals with suitable voltage, current, timing, etc., in order to make the display device show the desired image. The gamma settings of the display device 12, which encode the luminance values in the images displayed by the display device 12, can be adjusted via the display driver 64, such that, the default appropriate voltage that can be applied across the transparent electrodes 42, 44 to operate the display device 12 in the black state is changed from V_{black} (as in the default configuration settings) to the compensation voltage V_{c}, which is a voltage that is proportionally reduced from

$${V}_{black} by \frac{2 ϕ}{180} .$$

With continued reference to FIGS. 1-15, refer now to FIG. 17, which shows a flow diagram detailing the sub-steps of block 1608 for determining the compensation voltage V_{c}. The sub-steps are detailed as steps of a process (method) 1700. The process 1700 begins at block 1702, where the power supply arrangement 110 is configured to output a set output voltage between Vₘᵢₙ and Vₘₐₓ. At block 1704, the set output voltage is applied across the transparent electrodes 42, 44. In response to the applied voltage, the display module 60 emits image light waves, which traverse the optical arrangement 120 and are received at the image analyzer 130. At block 1706, the image analyzer 130 evaluates at least one image quality metric (preferably contrast ratio).

The sub-process 1700 then moves to block 1708, where the evaluated image quality metric is compared with a desired image quality metric value (i.e., the evaluated image quality metric is compared with a threshold value to determine whether the evaluated image quality metric satisfies a performance criterion), for example, an evaluated contrast ratio is compared with a desired contrast ratio. If the evaluated image quality metric satisfies the performance criterion, the process 1700 moves from block 1708 to block 1710, where the compensation voltage V_{c} is determined to be the output voltage. If the evaluated image quality metric does not satisfy the performance criterion (e.g., if the evaluated contrast ratio is below the desired contrast ratio), the process 1700 moves from block 1708 to block 1712, where the set output voltage (i.e., the voltage that is output by the power supply arrangement 110) is adjusted (increased or decreased) and set as a new output voltage. The process 1700 then returns to block 1704, and iterates on blocks 1704-1708 until the performance criterion is satisfied.

Some of the sub-processes of the process 1700 may be performed using computerized components (e.g., electronic control units, computer processors, etc.), and may be performed automatically or manually. For example, when employing the closed loop system discussed above, the control unit 140 is configured to: set the output voltage of the power supply arrangement 110 and actuate the power supply arrangement 110 to output the set voltage (as in block 1702), determine whether the evaluated image quality metric satisfies the performance criterion (as in block 1708), and adjust the output voltage of the power supply arrangement 110 and actuate the power supply arrangement 110 to output the adjusted voltage (as in block 1712).

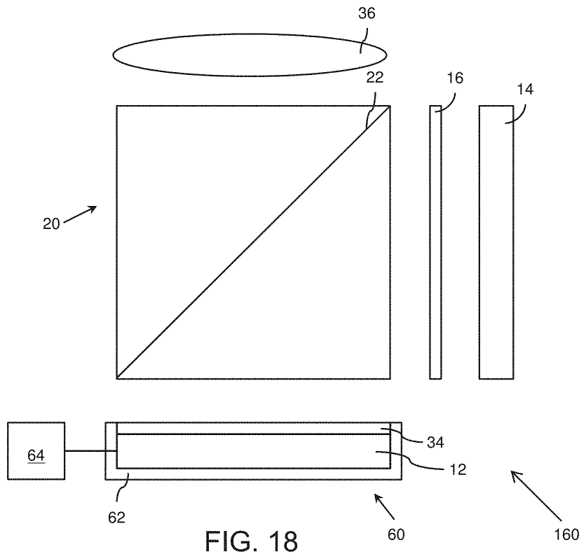

In practice, after completion of the execution of the process 1600 (and the process 1700), the display module 60—having a display device 12 a birefringent element 34 with deliberately misaligned Eigen axes but having the deliberate misaligned electronically compensated with a compensation voltage programmed via the display driver 64—may be deployed as part of an image projector. FIG. 18 shows such an image projector 160, which is generally similar to the image projector 10 of FIG. 1, except that the display device 12 and the birefringent element 34 have undergone steps for deliberate misalignment, electronic compensation for that misalignment, and reprogramming of gamma settings—through the display driver 64, via execution of the processes 1600 and 1700. Accordingly, similar to the image projector 10, the image projector 160 produces collimated polarized image light waves (typically p-polarized), generally designated as beam 19.

The image projector 160 can be used in a wide range of applications for which a microdisplay is needed. Examples of suitable applications include, but are not limited to, various imaging applications, such as near eye displays (NEDs), head mounted displays (HMDs), and head-up displays (HUDs) that utilize image projectors that project images into components of the NED, HMD, and HUD, cellular phones, compact displays, 3-D displays, compact beam expanders, as well as non-imaging applications, such as flat-panel indicators and scanners.

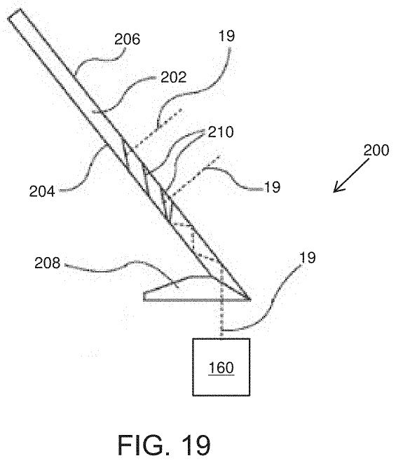

By way of illustration of one particularly preferred but non-limiting subset of applications, FIG. 19 illustrates an optical device 200, formed from the image projector 160 combined with a light-guiding substrate 202 that receives injected images from the image projector 160 and performs optical aperture expansion. The following paragraph provides a condensed description of the structure and functionality of the light-guiding substrate 202, however, more detailed description of the light-guiding substrate 202 may be found in the following PCT patent publications, the disclosures of which are incorporated by reference in their entirety herein: WO 01/95027, WO 2006/013565, WO 2006/085309, WO 2006/085310, WO 2007/054928, and WO 2008/023367. It is noted that the light-guiding substrate 202 described herein is merely an example of a light-guiding optical element with which the image projector 160 can be used to advantage.

The collimated image light waves (i.e., beam 19, also referred to as output light-waves 19) produced by the image projector 160 enter the light-guiding substrate 202. The light-guiding substrate 202 typically includes at least two major surfaces 204, 206 that are parallel to each other, one or more preferably mutually parallel partially reflecting surfaces 210 that are non-parallel to the major surfaces 204, 206, and an optical wedge element 208 for coupling light into the light-guiding substrate 202. The output light-waves 19 from the image projector 160 enter the light-guiding substrate 202 through the optical wedge element 208. The incoming light-waves (vis-a-vis the light-guiding substrate 202) are trapped in the light-guiding substrate 202 between the major surfaces 204, 206 by total internal reflection (TIR), as illustrated in FIG. 19. The outcoupling of the trapped light waves from the light-guiding substrate 202 can be applied by the partially reflecting surfaces 210 or by diffractive elements, or any other suitable outcoupling arrangement. The optical wedge element 208 is merely illustrative of one non-limiting optical coupling-in configuration, and other elements and configurations can be used to couple the light from the image projector 160 into light-guiding substrate 202.

Although the embodiments of the present disclosure have been described thus far within the context of a display device implemented as a liquid crystal on silicon microdisplay (in particular an LCoS configured to operate in normally white mode), the particular implementation of a normally white mode LCoS is merely illustrative of one non-limiting implementation of a liquid-crystal-based electronic display device for which the described methods and systems are applicable. It is emphasized that the methodologies of the embodiments of the present disclosure are equally applicable to other LCoS modal configurations, including, for example, LCoS that operates in normally dark mode, and other display devices that harness the polarization properties of liquid crystals, for example LCD devices.

It is noted that although the embodiments of the present disclosure have been described within the context of using contrast ratio as the image quality metric of interest, contrast ratio is merely illustrative of one non-limiting image quality metric, and other image quality metrics, including, but not limited to, modulation transfer function (MTF), can be used in addition to, or in place of, contrast ratio, as should be apparent to those of ordinary skill in the art.

Implementation of the method and/or system and/or device of embodiments of the invention can involve performing or completing selected tasks manually, automatically, or a combination thereof. Moreover, according to actual instrumentation and equipment of embodiments of the method and/or system and/or device of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system and/or device as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a RAM, a ROM, an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowcharts and block diagrams in the drawings illustrate the architecture, functionality, and operation of possible implementations of methods, systems and computer program products according to various embodiments of the present invention. In this regard, some of the blocks in the flowcharts, and blocks in the block diagrams, may represent a module, segment, or portion of code, which comprises one or more executable instructions for implementing the specified logical function(s). It should also be noted that, in some alternative implementations, the functions noted in the blocks of the flowcharts may occur out of the order noted in the drawings. For example, two blocks shown in succession may, in fact, be executed substantially concurrently, or the blocks may sometimes be executed in the reverse order, depending upon the functionality involved. It will also be noted that each block of the block diagrams and/or some of the blocks in the flowchart illustrations, and combinations of blocks in the block diagrams and/or some of the blocks in the flowchart illustrations, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form, “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the invention.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A method comprising:
obtaining an electronic display device and a birefringent element, the electronic display device having at least one layer of liquid crystal material deployed between two transparent electrodes, and the electronic display device and the birefringent element each having respective polarization axes;
deploying the electronic display device and the birefringent element relative to each other such that the polarization axes of the electronic display device are rotationally offset from the polarization axes of the birefringent element by an offset amount in accordance with a predetermined direction of rotation; and
determining a compensation voltage, proportional to the offset amount, that when applied across the transparent electrodes induces the liquid crystal material to assume an intermediate state, such that the electronic display device produces polarized image light waves having polarization in a polarization direction that is in accordance with the intermediate state assumed by the liquid crystal material and that compensates for the rotational offset between the polarization axes of the electronic display device and the birefringent element.

2. The method of claim 1, wherein the electronic display device comprises a liquid crystal on silicon display.

3. The method of claim 1, wherein the birefringent element includes a quarter wave plate.

4. The method of claim 1, wherein the birefringent element includes a full wave plate.

5. The method of claim 1, wherein the birefringent element includes a polarization compensator.

6. The method of claim 1, wherein the offset amount is within a predetermined range based on expected tolerances of the polarization axes of the electronic display device and the birefringent element.

7. The method of claim 1, wherein the determining the compensation voltage includes:
applying a voltage across the transparent electrodes, and
iteratively evaluating at least one image quality metric of the polarized image light waves produced in response to the applied voltage and adjusting the applied voltage until the at least one image quality metric satisfies a performance criterion.

8. The method of claim 1, further comprising:
passing the polarized image light waves emitted by the electronic display device through an optical arrangement prior to evaluating the at least one image quality metric.

9. (canceled)

10. (canceled)

11. (canceled)

12. (canceled)

13. (canceled)

14. (canceled)

15. A method for compensating for misalignment between a birefringent element and an electronic display device having at least one layer of liquid crystal material deployed between two transparent electrodes, the electronic display device and the birefringent element each having respective polarization axes, the electronic display device configured to receive a range of applied voltages across the transparent electrodes between a minimum voltage and a maximum voltage and including a default voltage, the method comprising:
deploying the electronic display device and the birefringent element relative to each other such that the polarization axes of the electronic display device are rotationally offset from the polarization axes of the birefringent element by an offset amount in accordance with a predetermined direction of rotation; and
applying a change to voltage setting of a display driver associated with the electronic display device such that the default voltage is proportionally reduced in accordance with the offset amount to produce a proportionally reduced default voltage, and such that when the proportionally reduced default voltage is applied across the transparent electrodes the liquid crystal material assumes an intermediate state such that the electronic display device produces polarized image light waves having polarization in a polarization direction that is in accordance with the intermediate state assumed by the liquid crystal material and that compensates for the rotational offset between the polarization axes of the electronic display device and the birefringent element.

16. A display module comprising:
an electronic display device including at least one layer of liquid crystal material deployed between two transparent electrodes, the liquid crystal material having polarization axes that define polarization axes of the electronic display device, the electronic display device associated with a display driver that controls voltage settings associated with the electronic display device, the voltage settings including a default voltage that can be applied across the transparent electrodes; and
a birefringent element optically coupled to the electronic display device and having polarization axes,
wherein the electronic display device and the birefringent element are deployed relative to each other such that the polarization axes of the electronic display device are rotationally offset from the polarization axes of the birefringent element by an offset amount in accordance with a predetermined direction of rotation, and
wherein the voltage settings of the display driver are changed such that the default voltage is proportionally reduced in accordance with the offset amount to produce a proportionally reduced default voltage, and such that when the proportionally reduced default voltage is applied across the transparent electrodes the liquid crystal material assumes an intermediate state such that the electronic display device produces polarized image light waves having polarization in a polarization direction that is in accordance with the intermediate state assumed by the liquid crystal material and that compensates for the rotational offset between the polarization axes of the electronic display device and the birefringent element.

17. The display module of claim 16, wherein the electronic display device is configured to operate in a normally white mode.

18. The display module of claim 16, wherein the electronic display device is configured to operate in a normally dark mode.

19. The display module of claim 16, wherein the electronic display device comprises a liquid crystal on silicon display, and wherein one of the transparent electrodes is deployed between the at least one layer of liquid crystal and a reflecting surface.

20. An image projector for projecting image light waves, comprising:
the display module of claim 19;
a prim including:
a plurality of external surfaces including a light-wave entrance surface, an image display surface associated with the electronic display device, and a light-wave exit surface, and
a polarization sensitive beamsplitter configuration deployed within the prism on a plane oblique to the light-wave entrance surface; and
a source of polarized light associated with the light-wave entrance surface configured to produce linearly polarized light,
such that polarized light produced by the source of polarized light enters the prism through the light-wave entrance surface, is reflected by the polarization sensitive beamsplitter configuration, impinges on the electronic display device via the image display surface such that the electronic display device generates spatial modulation of the polarized light corresponding to an image and such that the polarized light is reflected by the reflecting surface and has a polarization rotated relative to the source of polarized light, and such that the reflected light re-enters the prism via the image display surface and is transmitted by the polarization sensitive beamsplitter configuration, and exits the prism through the light-wave exit surface.

21. An optical device comprising:
the image projector of claim 20; and
a light-guiding substrate having at least two major surfaces parallel to each other, wherein the projected image light waves produced by the image projector are coupled into the light-guiding substrate.
